(19) United States
(12) Patent Application Publication
(10) Pub. No.: US 2026/0009691 A1
(43) Pub. Date: Jan. 8, 2026

(54) FLUID LEAK MONITORING SYSTEM FOR POUCH TYPE BATTERY

(71) Applicant: BeomYong Heater Co., Ltd., Siheung-si (KR)

(72) Inventor: Tae Yang LEE, Siheung-si (KR)

(73) Assignee: BeomYong Heater Co., Ltd., Siheung-si (KR)

(21) Appl. No.: 19/327,849

(22) Filed: Sep. 12, 2025

(30) Foreign Application Priority Data
Jun. 24, 2024 (KR) 10-2024-0082138

(51) Int. Cl. G01M 3/04; H01M 10/42; H01M 50/105

(52) U.S. Cl. CPC G01M 3/04; H01M 10/4228; H01M 10/4285; H01M 50/105

(57) ABSTRACT

Proposed is a fluid-leak monitoring system for a pouch type battery, and the system includes a battery cell configured to include an electrode assembly including a positive electrode and a negative electrode, and a pouch film that is arranged in a form covering outer sides of the electrode assembly, so as to accommodate the electrode assembly and an electrolyte in an internal space and is provided with a sealing part having opposite sides bonded at one or more edges along a circumference, so as to seal the internal space, a sensor module arranged at an outer end of the weak part, and configured to output a fluid-leak detection signal when the electrolyte is detected, and a fluid-leak notification unit installed in a form of an application on a user terminal or provided as a part of a vehicle system, and configured to establish a signal connection with the sensor module.

### BACKGROUND OF THE INVENTION

### Field of the Invention

The present disclosure relates to a fluid leak monitoring system for a pouch type battery and, more particularly, to a fluid leak monitoring system for a pouch type battery, the system monitoring whether an electrolyte inside a battery cell leaks to the outside due to excessive increase in internal pressure, so as to enable a user recognize the leakage status of the electrolyte in a timely manner.

### Description of the Related Art

Typically, electric vehicles or hybrid vehicles are equipped with a battery pack used as a power source, and a plurality of battery cells is provided inside the battery pack. In addition, in case of pouch type battery cells, a battery cell is formed in a structure where an electrode assembly and electrolyte are sealed by a pouch film, and when the battery cell overheats or the internal pressure increases due to abnormal operation, the pouch film becomes unable to withstand the heat or pressure and bursts, causing a phenomenon that the electrolyte inside leaks to the outside.

In addition, an electrolyte contains sulfuric acid, so in a case where the electrolyte leaks into the interior of a battery pack or a vehicle, there is a problem that the battery pack or the vehicle may easily be corroded, and a vehicle fire may easily occur due to a low ignition temperature of the electrolyte and the generation of flammable gas.

### DOCUMENTS OF RELATED ART

Patent Document 0001 Korea Patent No. 10-2157495 Sep. 18, 2020, POUCH TYPE BATTERY CELL AND MANUFACTURING METHOD THEREOF

### SUMMARY OF THE INVENTION

The embodiment of the present disclosure is devised to solve the above-described problems, and an objective of the present disclosure is to provide a fluid leak monitoring system for a pouch type battery, the system monitoring whether an electrolyte inside a battery cell leaks to the outside due to excessive increase in internal pressure, so as to inform a user of the risk of electrolyte leakage, thereby enabling prevention the corrosion of a battery pack or a vehicle, or the occurrence of a vehicle fire by timely measures.

According to a characteristic of the present disclosure, there is provided a fluid leak monitoring system for a pouch-type battery, the system including: a battery cell 110 configured to include an electrode assembly 111 including a positive electrode 112 and a negative electrode 113, and a pouch film 115 that is arranged in a form covering outer sides of the electrode assembly 111, so as to accommodate the electrode assembly 111 and an electrolyte 114 in an internal space 116 and is provided with a sealing part 117 having opposite sides bonded at one or more edges along a circumference thereof, so as to seal the internal space 116, have the sealing part 117 including a weak part 118 having relatively lower bond strength than that of other part 119, and have the weak part 118 extending from an inner space 116 side toward an outer end on the sealing part 117 and guiding the electrolyte 114 inside to move along the weak part 118 to the outer end of the sealing part 117 as a bond opens when excessive pressure occurs in the inner space 116; a sensor module 120 arranged at an outer end of the weak part 118, and configured to output fluid leak detection signal when the electrolyte 114 is detected; and a fluid leak notification unit 130 installed in a form of an application on a user terminal 310 or provided as a part of a vehicle system 320, and configured to establish a signal connection with the sensor module 120, so as to notify of a risk of leakage of the electrolyte 114 through the user terminal 310 or the vehicle system 320 when the fluid leak detection signal is input.

According to another characteristic of the present disclosure, there is provided the fluid leak monitoring system for the pouch type battery, in which the weak part 118 is formed to have the bond strength relatively lower than that of the other part 119 because of being relatively less pressurized than the other part 119 by a weak part forming groove 211 formed at a position corresponding to the weak part 118 on any one or more of a first mold 210 and a second mold 220 when the sealing part 117 is compressed between the first mold 210 and the second mold 220.

According to a yet another characteristic of the present disclosure, there is provided the fluid leak monitoring system for the pouch type battery, in which the weak part 118 is formed to extend from the inner space 116 side toward the outer end on the sealing part 117, and is formed with a bent part 118a laterally bent between one side in contact with the inner space 116 and the other side in contact with the outer end, so as to cause a momentary excessive pressure, which is introduced from the inner space 116 to the one side, to be collided with the bent part 118a and be mitigated.

According to a still another characteristic of the present disclosure, there is provided the fluid leak monitoring system for the pouch type battery, in which a weak part 118 is formed to extend from an inner space 116 toward an outer end on a sealing part 117, and is formed to extend in a form in which a plurality of high-pressure parts 118b, which is bonded with a first bond strength along an extended length, and a plurality of low-pressure parts 118c, which is bonded or not bonded with a second bond strength relatively lower than the first bond strength, are alternately arranged.

According to a still another characteristic of the present disclosure, there is provided the fluid leak monitoring system for the pouch type battery, in which the sealing portion 117 is formed as opposite sides of the pouch film 115 are thermally or ultrasonically pressed between the first mold 210 and the second mold 220, and the weak part 118 is formed to have the bond strength relatively lower than that of the other part 119 because of being relatively heated less than the other part 119 by a cooling part 230 arranged at a position corresponding to the weak part 118 on any one or more of the first mold 210 and the second mold 220.

According to a still another characteristic of the present disclosure, there is provided the fluid leak monitoring system for the pouch type battery, in which the sealing portion 117 is formed as opposite sides of the pouch film 115 are thermally or ultrasonically pressed between the first mold 210 and the second mold 220, and the weak part 118 is formed to have the bond strength relatively lower than that of the other part 119 because of being relatively heated less than the other part 119 by an insulating material 240 arranged at a position corresponding to the weak part 118 on any one or more of the first mold 210 and the second mold 220 and having a relatively lower thermal conductivity than that of each mold 210 and 220.

According to a still another characteristic of the present disclosure, there is provided the fluid leak monitoring system for the pouch type battery, in which the sealing part 117 is formed as opposite sides of the pouch film 115 are thermally or ultrasonically compressed between the first mold 210 and the second mold 220, a heterogeneous member 140 made of a material different from the sealing part 117 is provided at a position where the weak part 118 is formed on the sealing part 117, and the heterogeneous member 140 is made of a material whose bond strength generated by thermal or ultrasonic compression of each mold 210 and 220 is relatively lower than that of the sealing part 117.

According to a still another characteristic of the present disclosure, there is provided the fluid leak monitoring system for the pouch type battery, in which the heterogeneous member 140 is made of a member that has a relatively higher melting point than the sealing member 117, does not melt by the thermal compression or ultrasonic compression, or has a relatively smaller molecular structure than the sealing member 117.

According to a still another characteristic of the present disclosure, there is provided the fluid leak monitoring system for the pouch type battery, the system further including: a leakage fluid accommodation chamber 150 arranged at the outer end of the weak part 118 and having an accommodation space 151 formed therein and connected to the weak part 118, so as to accommodate the electrolyte 114 leaked through the weak part 118 therein, wherein the sensor module 120 is equipped in the leakage fluid accommodation chamber 150, so as to detect the electrolyte 114 flowing into the accommodation space 151.

Meanwhile, according to a still another characteristic of the present disclosure, there is provided the fluid leak monitoring system for the pouch type battery, in which a weak part 118 is formed to extend from an inner space 116 side toward an outer end on a sealing part 117 so that one side thereof is in contact with the inner space 116 and the other side thereof is in contact with the outer end, and may be provided with an inflow guide part 118d that is configured not to be bonded or configured in a form whose bond strength is relatively lower than that of other part of the weak part 118 at a position of the one side in contact with the internal space 116 and is configured in a form whose size gradually increases toward the outer end, thereby guiding pressure generated in the internal space 116 to be concentrated on the other side of the weak part 118.

According to the present disclosure as described above,

First, a battery cell 110 is configured to include an electrode assembly 111 including a positive electrode 112 and a negative electrode 113, and a pouch film 115 that is arranged in a form covering outer sides of the electrode assembly 111, so as to accommodate the electrode assembly 111 and an electrolyte 114 in an internal space 116 and is provided with a sealing part 117 having opposite sides bonded at one or more edges along a circumference thereof, so as to seal the internal space 116, have the sealing part 117 including a weak part 118 having relatively lower bond strength than that of other part 119, and have the weak part 118 extending from an inner space 116 side toward an outer end on the sealing part 117 and guiding the electrolyte 114 inside to move along the weak part 118 to the outer end of the sealing part 117 as a bond opens when excessive pressure occurs in the inner space 116, a sensor module 120 is arranged at an outer end of the weak part 118, and is configured to output a fluid leak detection signal when the electrolyte 114 is detected, and a fluid leak notification unit 130 is installed in a form of an application on a user terminal 310 or provided as a part of a vehicle system 320, and is configured to establish a signal connection with the sensor module 120, so as to notify of a risk of leakage of the electrolyte 114 through the user terminal 310 or the vehicle system 320 when the fluid leak detection signal is input, so that as described above, the system monitors whether an electrolyte inside a battery cell leaks to the outside due to excessive increase in internal pressure, so as to inform a user of the risk of electrolyte leakage, thereby enabling prevention of battery pack corrosion, vehicle corrosion, or a vehicle fire by timely measures.

Second, the weak part 118 is formed to have the bond strength relatively lower than that of the other part 119 because of being relatively less pressurized than the other part 119 by a weak part forming groove 211 formed at a position corresponding to the weak part 118 on any one or more of a first mold 210 and a second mold 220 when the sealing part 117 is compressed between the first mold 210 and the second mold 220, so that it is possible to produce the bond strength of the weak part 118 to be constant and reduce the production cost and production time significantly, whereby conditions for mass production may be provided.

Third, the weak part 118 is formed to extend from the inner space 116 side toward the outer end on the sealing part 117, and is formed with a bent part 118a laterally bent between one side in contact with the inner space 116 and the other side in contact with the outer end, so as to cause a momentary excessive pressure, which is introduced from the inner space 116 to the one side, to be collided with the bent part 118a and be mitigated, whereby it is possible to prevent in advance a phenomenon in which the weak part 118 in the bonding status opens at once due to a momentary excessive pressure that may occur inside the battery cell 110 when strong external pressure is applied to the battery cell 110 or due to abnormal operation of the battery cell 110.

Fourth, a weak part 118 is formed to extend from an inner space 116 toward an outer end on a sealing part 117, and is formed to extend in a form in which a plurality of high-pressure parts 118b, which is bonded with a first bond strength along an extended length, and a plurality of low-pressure parts 118c, which is bonded or not bonded with a second bond strength relatively lower than the first bond strength, are alternately arranged, whereby it is possible to prevent the weak part 118 from being opened at once due to a momentary excessive pressure by allowing a bond of each high-pressure part 118b to be opened sequentially under the pressure generated inside a battery cell 110.

Fifth, the sealing portion 117 is formed as opposite sides of the pouch film 115 are thermally or ultrasonically pressed between the first mold 210 and the second mold 220, and the weak part 118 is formed to have the bond strength relatively lower than that of the other part 119 because of being relatively heated less than the other part 119 by a cooling part 230 or an insulating member 240, which is arranged at a position corresponding to the weak part 118 on any one or more of the first mold 210 and the second mold 220, whereby there is no need to form a weak part forming groove 211 in each mold 210 and 220, and a formation location of the weak part 118 may be freely controlled depending on the type, size, and structure of a battery cell 110.

Sixth, the sealing part 117 is formed as opposite sides of the pouch film 115 are thermally or ultrasonically compressed between the first mold 210 and the second mold 220, a heterogeneous member 140 made of a material different from the sealing part 117 is provided at a position where the weak part 118 is formed on the sealing part 117, and the heterogeneous member 140 is made of a material whose bond strength generated by thermal or ultrasonic compression of each mold 210 and 220 is relatively lower than that of the sealing part 117, whereby there is no need to form a weak part forming groove 211 in a first mold 210 and a second mold 220, and a formation location of the weak part 118 may be freely controlled depending on the type, size, and structure of the battery cell 110.

Seventh, a leakage fluid accommodation chamber 150 is arranged at an outer end of a weak part 118 and has an accommodation space 151 formed therein and connected to the weak part 118 so as to accommodate an electrolyte 114 therein leaked through the weak part 118. A sensor module 120 is arranged in the leakage fluid accommodation chamber 150 and is configured to detect the electrolyte 114 flowing into the accommodation space 151, whereby it is possible to notify a user of leakage status of the electrolyte 114 while fundamentally preventing the electrolyte 114, which is discharged through the weak part 118, from leaking into the interior of the battery pack or the interior of the vehicle.

Eighth, a weak part 118 is formed to extend from an inner space 116 side toward an outer end on a sealing part 117 so that one side thereof is in contact with the inner space 116 and the other side thereof is in contact with the outer end, and may be provided with an inflow guide part 118d that is configured not to be bonded or configured in a form whose bond strength is relatively lower than that of other part of the weak part 118 at a position of the one side in contact with the internal space 116 and is configured in a form whose size gradually increases toward the outer end, thereby guiding pressure generated in the internal space 116 to be concentrated on the other side of the weak part 118, and thus during a production process, even when an unintentional weak part with relatively lower bond strength than that of the weak part 118 is formed on the sealing part 117 or an unintentional weak part with relatively lower bond strength than that of the weak part 118 is formed on the sealing part 117 due to internal pressure of a battery cell 110 after being installed in a battery pack, the phenomenon in which a part other than the weak part 118 bursts due to excessive pressure may be prevented by allowing the pressure generated internally to be applied toward the weak part 118 through the inflow guide part 118d.

### BRIEF DESCRIPTION OF THE DRAWINGS

FIGS. 1A and 1B are schematic views illustrating each configuration of a fluid leak monitoring system for a pouch type battery according to one preferred exemplary embodiment of the present disclosure.

FIG. 2 is a plan view illustrating a state in which a sensor module is equipped on a battery cell according to one preferred exemplary embodiment of the present disclosure.

FIG. 3 is an exploded perspective view illustrating a configuration of a battery cell according to one preferred exemplary embodiment of the present disclosure.

FIGS. 4 to 6B are a perspective view and side cross-sectional views illustrating one exemplary embodiment for forming a weak part in a sealing part of a pouch film according to the preferred exemplary embodiment of the present disclosure.

FIGS. 7A and 7B are a plan view and a perspective view, illustrating various shapes of weak parts according to one preferred exemplary embodiment of the present disclosure.

FIGS. 8A to 8D are perspective views illustrating mold structures for forming weak parts according to one preferred exemplary embodiment of the present disclosure.

FIGS. 9A and 9B are perspective views illustrating respective configurations of a cooling part and an insulating member according to one preferred exemplary embodiment of the present disclosure.

FIG. 10 is a cross-sectional side view illustrating a configuration of a heterogeneous member according to one preferred exemplary embodiment of the present disclosure.

FIG. 11 is a cross-sectional side view illustrating a configuration of a leakage fluid accommodation chamber according to one preferred exemplary embodiment of the present disclosure.

FIG. 12 is a cross-sectional side view illustrating a configuration of an inflow guide part according to one preferred exemplary embodiment of the present disclosure.

### DETAILED DESCRIPTION OF THE INVENTION

The objectives, features, and advantages of the present disclosure described above will become more apparent through the following detailed description. Hereinafter, preferred exemplary embodiments of the present disclosure will be described with reference to the attached drawings.

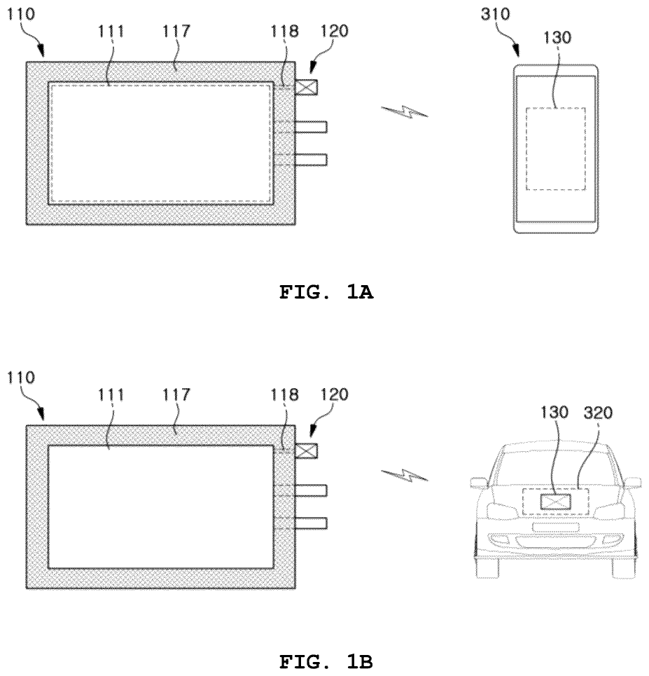

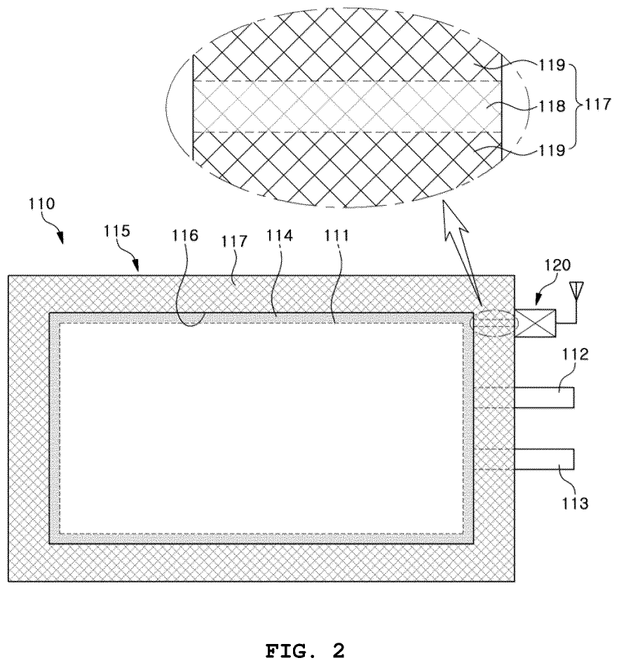

A fluid leak monitoring system for a pouch type battery according to one preferred exemplary embodiment of the present disclosure is a system configured to prevent the corrosion of a battery pack or a vehicle, or the occurrence of a vehicle fire by monitoring leakage of an internal electrolyte to the outside due to excessive increase in internal pressure of a battery cell and enabling a user to recognize the leakage status of the electrolyte in a timely manner. As illustrated in FIG. 1, the system includes a battery cell 110, a sensor module 120, and a fluid leak notification part 130.

First, the battery cell 110 includes a battery cell 110 configured to include an electrode assembly 111 including a positive electrode 112 and a negative electrode 113, and a pouch film 115 that is arranged in a form covering outer sides of the electrode assembly 111, so as to accommodate the electrode assembly 111 and an electrolyte 114 in an internal space 116 and is provided with a sealing part 117 having opposite sides bonded at one or more edges along a circumference thereof, so as to seal the internal space 116.

Here, the electrode assembly 111 may be a stack type electrode laminate formed by alternately laminating the positive electrode 112 and the negative electrode 113 while interposing each separation membrane sheet therebetween, or may be a stack-folding type electrode laminate formed by alternately laminating the positive electrode 112 and the negative electrode 113 by alternately inserting the positive electrode 112 and the negative electrode 113 while folding a single long rectangular separation membrane in a zigzag shape, or may be a winding type electrode laminate formed by alternately laminating the negative electrode 113 and the positive electrode 112 having a separation membrane as a boundary while winding the rectangular separation membrane in one direction, or may be a jelly roll type electrode laminate formed by winding, in one direction, a long rectangular positive electrode 112 and negative electrode 113 while winding a separation membrane interposed between each electrode together. Furthermore, the electrode assembly 111 may also be formed by combining two or more of the various types of assembly structures described above.

In addition, the sealing part 117 includes a weak part 118 having relatively lower bond strength than that of other part 119. The weak part 118 extends from an inner space 116 side toward an outer end on the sealing part 117, so that as a bond opens when excessive pressure occurs in the inner space 116, the electrolyte 114 inside is guided to move along the weak part 118 to the outer end of the sealing part 117.

The other part 119 refers to the remaining part of the sealing part 117 excluding the weak part 118. Each of the weak part 118 and the other part 119 has bond strength satisfying design bond strength required for the sealing part 117 of the battery cell 110, but may be distinguished from each other in that the other part 119 is formed to have relatively higher bond strength than that of the weak part 118.

The sensor module 120 is arranged on an outer end of the weak part 118 and outputs a fluid leak detection signal when the electrolyte 114 is detected. Here, the sensor module 120 may be arranged on the weak part 118 to detect the electrolyte 114 flowing into the interior of the weak part 118, or may also be arranged at the end of the weak part 118, i.e., the outer end of the sealing part 117, to detect the electrolyte 114 discharged through the weak part 118.

In addition, the sensor module 120 may be provided with a sensor member for detecting the inflow and discharge of the electrolyte 114, and may detect contact with the electrolyte 114 or detect a change in the internal pressure of the weak part 118 due to the inflow of the electrolyte 114. Furthermore, the sensor module 120 may utilize sensor members having various detection methods for detecting the inflow into the interior of the weak part 118 or the discharge from the outer end as the bond of the weak part 118 opens.

The fluid leak notification part 130 is installed in the form of an application on a user terminal 310 or is provided as a part of a vehicle system 320, and is provided to establish a signal connection with the sensor module 120, so as to notify the user terminal 310 or the vehicle system 320 of the risk of leakage of the electrolyte 114 when the fluid leak detection signal is input.

Here, as illustrated in FIG. 1A, the fluid leak notification part 130 establishes the signal connection wired or wirelessly with the sensor module 120 and receives a fluid leak detection signal output from the sensor module 120, and when the fluid leak detection signal is received, the risk of leakage is notified to the user terminal 310 through a display means such as a character, an image, a sound, or lighting, which is preset. The user terminal 310 may be a smartphone, a tablet, or a PC. In addition, various types of communication devices capable of establishing the signal connection with the sensor module 120 and provided with data processing and operation functions may be used as the user terminal 310.

In addition, as illustrated in FIG. 1B, the fluid leak notification part 130 establishes the signal connection wire or wirelessly with the vehicle system 320, which is provided in a vehicle, to receive a fluid leak detection signal output from the sensor module 120, and when the fluid leak detection signal is received, the risk of leakage is allowed to be notified through various display means through the vehicle system 320. The vehicle system 320 is a system provided in the vehicle and may include various input/output devices such as an ECU, a navigation device, a monitor, and a speaker, and depending on the type of vehicle, the target of the input/output devices included may vary.

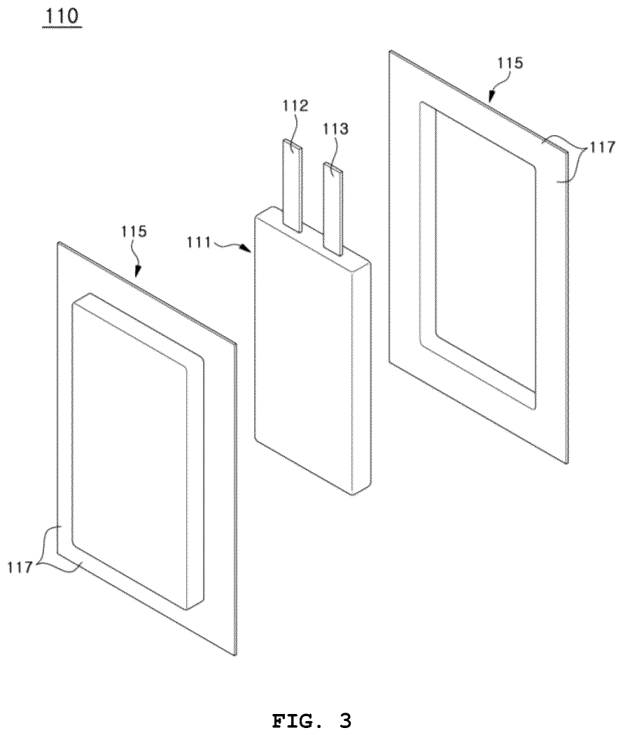

In addition, as illustrated in FIG. 3, the pouch film 115 may be arranged so as to allow two sheets of a pouch film 115 to face each other, having the electrode assembly 111 placed therebetween, whereby as the opposite sides are bonded, the electrode assembly 111 and the electrolyte 114 are accommodated therein in a sealed state. In addition, as one sheet of a pouch film 115 is folded to seal one side edge thereof, and as the opposite sides of the remaining open edges are bonded, the interior can be sealed.

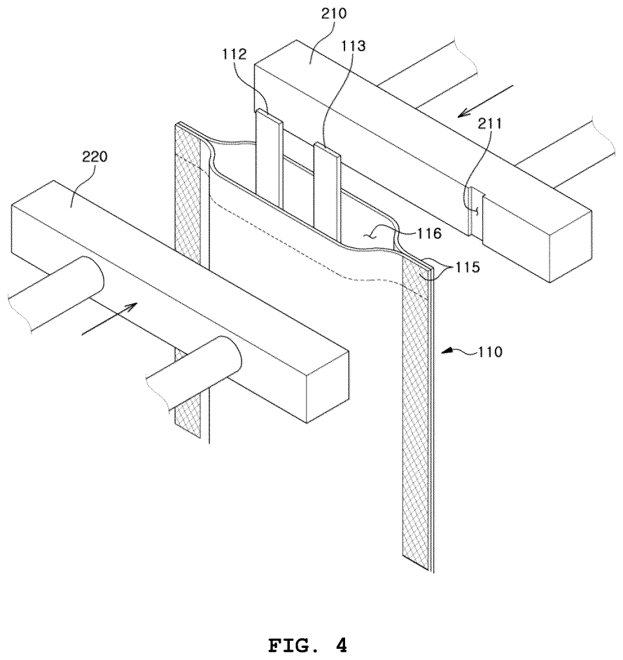

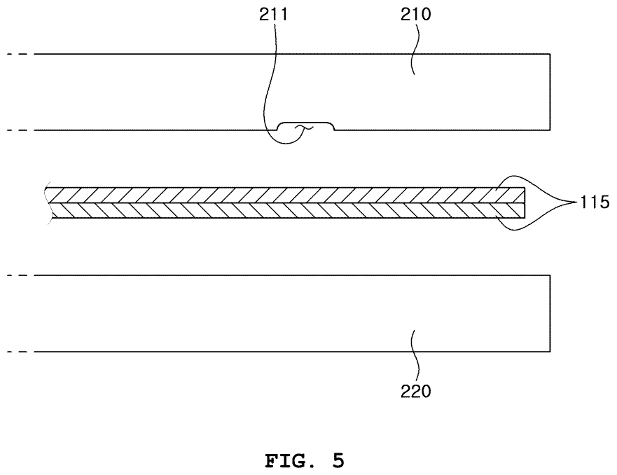

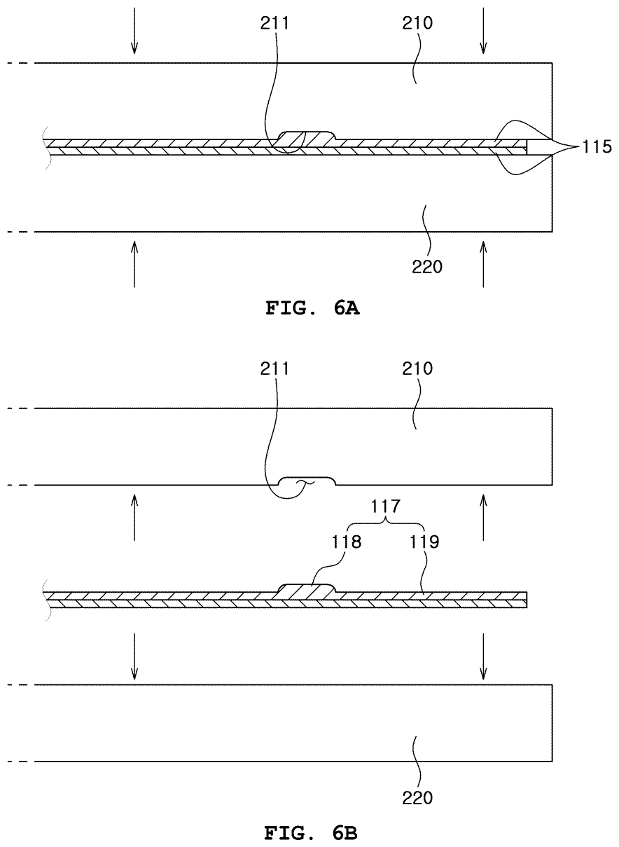

In addition, as illustrated in FIGS. 4 to 6B, the weak part 118 is formed to have the bond strength relatively lower than that of the other part 119 because of being relatively less pressurized than the other part 119 by a weak part forming groove 211 formed at a position corresponding to the weak part 118 on any one or more of a first mold 210 and a second mold 220 when the sealing part 117 is compressed between the first mold 210 and the second mold 220.

Accordingly, it is possible to produce the bond strength of the weak part 118 to be constant and reduce the production cost and production time significantly, whereby conditions for mass production may be provided.

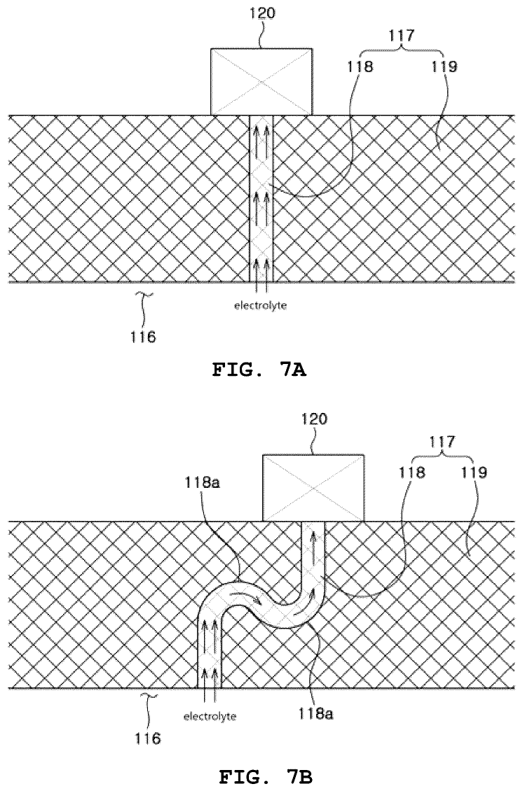

In addition, as illustrated in FIG. 7A, in a case where a weak part 118 extends linearly from an inner space 116 side toward an outer end on a sealing part 117, the entire weak part 118 may be opened with a single strong excessive pressure because the pressure is applied in the extended direction of the weak part 118 when a momentary excessive pressure is applied to a battery cell 110.

Accordingly, as illustrated in FIG. 7B, the weak part 118 is formed to extend from the inner space 116 side toward the outer end on the sealing part 117, and is formed with a bent part 118a laterally bent between one side in contact with the inner space 116 and the other side in contact with the outer end, so as to cause a momentary excessive pressure, which is introduced from the inner space 116 to the one side, to be collided with the bent part 118a and be mitigated, whereby it is possible to prevent in advance a phenomenon in which the weak part 118 in the bonding status opens at once due to a momentary excessive pressure that may occur inside the battery cell 110 when strong external pressure is applied to the battery cell 110 or due to abnormal operation of the battery cell 110.

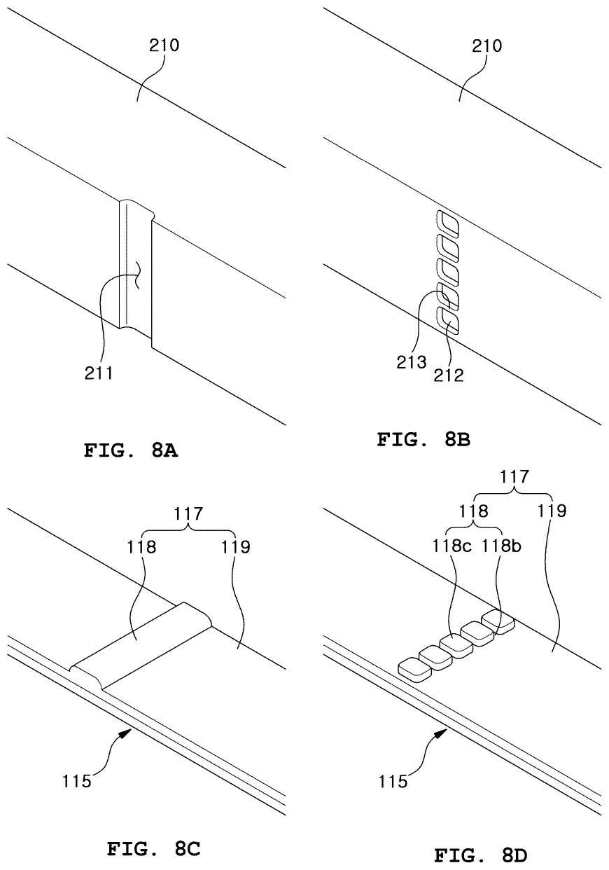

In addition, as illustrated in FIG. 8A, a weak part forming groove 211 formed in each mold 210 and 220 may have a linearly extended shape, and in this case, as illustrated in FIG. 8C, a weak part 118 formed in a pouch film 115 is also formed to be linearly extended.

In addition, as illustrated in FIG. 8D, a weak part 118 is formed to extend from an inner space 116 toward an outer end on a sealing part 117, and is formed to extend in a form in which a plurality of high-pressure parts 118b, which is bonded with a first bond strength along an extended length, and a plurality of low-pressure parts 118c, which is bonded or not bonded with a second bond strength relatively lower than the first bond strength, are alternately arranged, whereby it is possible to prevent the weak part 118 from being opened at once due to a momentary excessive pressure by allowing a bond of each high-pressure part 118b to be opened sequentially under the pressure generated inside a battery cell 110.

To this end, as illustrated in FIG. 8B, the weak part forming groove 211 formed in each mold 210 and 220 may be formed by dividing it into a low-pressure groove part 212 having a relatively deep sunken depth and a high-pressure groove part 213 having a relatively shallower sunken depth than that of the low-pressure groove part 212 or having no sunken depth.

In addition to the method of forming the weak part 118 using the weak part forming groove 211, other methods are described.

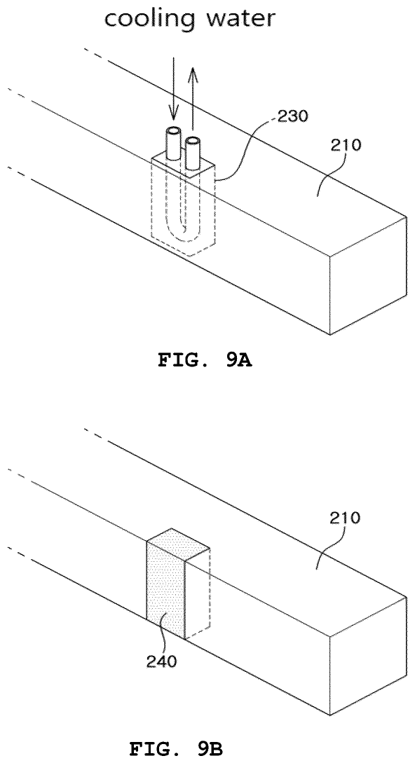

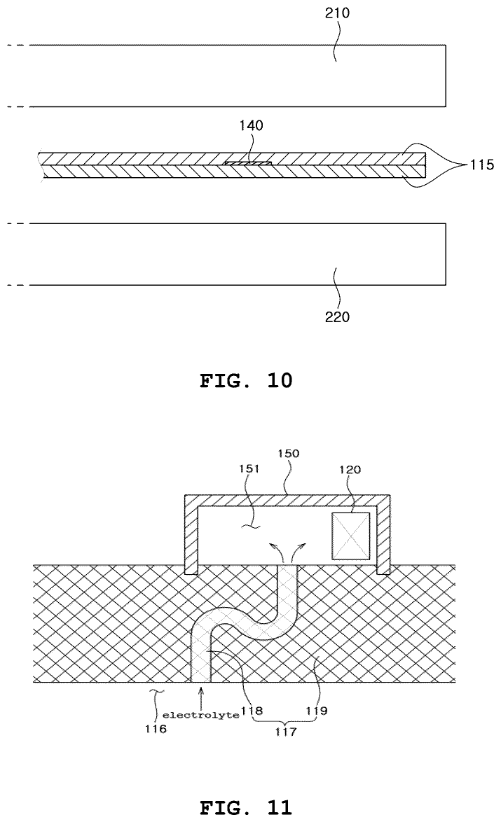

Referring to FIG. 9A, the sealing portion 117 is formed as opposite sides of the pouch film 115 are thermally or ultrasonically pressed between the first mold 210 and the second mold 220, and the weak part 118 is formed to have the bond strength relatively lower than that of the other part 119 because of being relatively heated less than the other part 119 by a cooling part 230 arranged at a position corresponding to the weak part 118 on any one or more of the first mold 210 and the second mold 220.

Here, as illustrated in the drawing, the cooling part 230 is provided to receive the supply of cooling water from the outside, and may maintain a temperature relatively lower than that of each mold 210 and 220, which is heated at a high temperature by a heater not shown.

In addition, referring to FIG. 9B, the sealing portion 117 is formed as opposite sides of the pouch film 115 are thermally or ultrasonically pressed between the first mold 210 and the second mold 220, and the weak part 118 is formed to have the bond strength relatively lower than that of the other part 119 because of being relatively heated less than the other part 119 by an insulating part 240 arranged at a position corresponding to the weak part 118 on any one or more of the first mold 210 and the second mold 220.

As such, through the configurations of the cooling part 230 and the insulating member 240, there is no need to form a weak part forming groove 211 in each mold 210 and 220, and a formation location of the weak part 118 may be freely controlled depending on the type, size, and structure of a battery cell 110.

In addition, the sealing part 117 is formed as opposite sides of the pouch film 115 are thermally or ultrasonically compressed between the first mold 210 and the second mold 220, a heterogeneous member 140 made of a material different from the sealing part 117 is provided at a position where the weak part 118 is formed on the sealing part 117, and the heterogeneous member 140 is made of a material whose bond strength generated by thermal or ultrasonic compression of each mold 210 and 220 is relatively lower than that of the sealing part 117.

Such a heterogeneous member 140 is made of a member that has a relatively higher melting point than the sealing member 117, does not melt by the thermal compression or ultrasonic compression, or has a relatively smaller molecular structure than the sealing member 117.

Accordingly, there is no need to form a weak part forming groove 211 in the first mold 210 and the second mold 220, and the formation location of the weak part 118 may be freely controlled depending on the type, size, and structure of the battery cell 110.

Meanwhile, as illustrated in FIG. 11, a leakage fluid accommodation chamber 150 is arranged at an outer end of a weak part 118 and has an accommodation space 151 formed therein and connected to the weak part 118 so as to accommodate an electrolyte 114 therein leaked through the weak part 118. A sensor module 120 is arranged in the leakage fluid accommodation chamber 150 and is configured to detect the electrolyte 114 flowing into the accommodation space 151.

Accordingly, it is possible to notify a user of leakage status of the electrolyte 114 while fundamentally preventing the electrolyte 114, which is discharged through the weak part 118, from leaking into the interior of the battery pack or the interior of the vehicle.

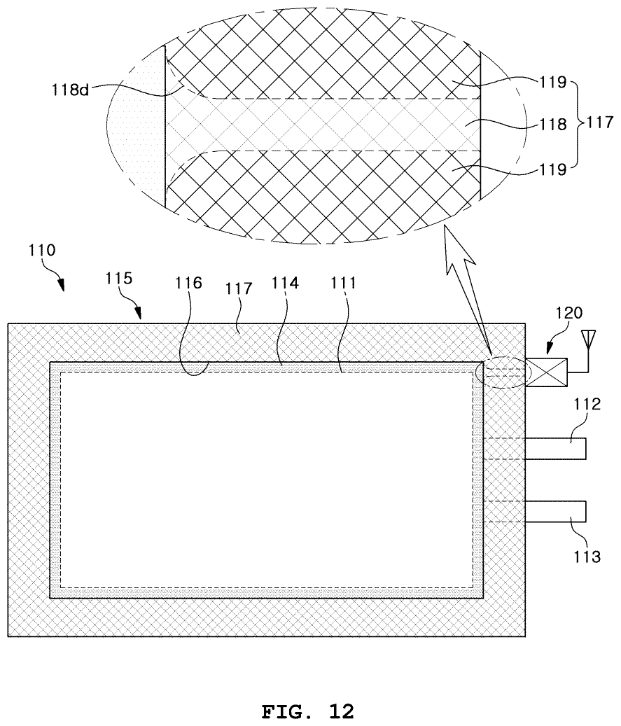

In addition, as illustrated in FIG. 12, a weak part 118 is formed to extend from an inner space 116 side toward an outer end on a sealing part 117 so that one side thereof is in contact with the inner space 116 and the other side thereof is in contact with the outer end, and may be provided with an inflow guide part 118d that is configured not to be bonded or configured in a form whose bond strength is relatively lower than that of other part of the weak part 118 at a position of the one side in contact with the internal space 116 and is configured in a form whose size gradually increases toward the outer end, thereby guiding pressure generated in the internal space 116 to be concentrated on the other side of the weak part 118.

Through such an inflow guide part 118d, during a production process, even when an unintentional weak part with relatively lower bond strength than that of the weak part 118 is formed on the sealing part 117 or an unintentional weak part with relatively lower bond strength than that of the weak part 118 is formed on the sealing part 117 due to internal pressure of a battery cell 110 after being installed in a battery pack, the phenomenon in which a part other than the weak part 118 bursts due to excessive pressure may be prevented by allowing the pressure generated internally to be applied toward the weak part 118 through the inflow guide part 118d.

Meanwhile, in the above description, as a method for forming the sealing part 117 in the pouch film 115, the pressing method using the first mold 210 and the second mold 220 is exemplarily described, but it is not limited thereto, so a rolling pressing method using a pressure roll and a bonding attachment method using a bonding agent may also be used.

The present disclosure described above is not limited by the above-described exemplary embodiments and the accompanying drawings, and obviously, those skilled in the art will appreciate that various substitutions, modifications, and changes are possible within the scope of the technical spirit of the present disclosure.

What is claimed is:

1. A fluid leak monitoring system for a pouch-type battery, the system comprising:
a battery cell (110) configured to comprise an electrode assembly (111) comprising a positive electrode (112) and a negative electrode (113), and a pouch film (115) that is arranged in a form covering outer sides of the electrode assembly (111), so as to accommodate the electrode assembly (111) and an electrolyte (114) in an internal space (116) and is provided with a sealing part (117) having opposite sides bonded at one or more edges along a circumference thereof, so as to seal the internal space (116), have the sealing part (117) comprising a weak part (118) having relatively lower bond strength than that of other part (119), and have the weak part (118) extending from an inner space (116) side toward an outer end on the sealing part (117) and guiding the electrolyte (114) inside to move along the weak part (118) to the outer end of the sealing part (117) as a bond opens when excessive pressure occurs in the inner space (116);
a sensor module (120) arranged at an outer end of the weak part (118), and configured to output a fluid leak detection signal when the electrolyte (114) is detected; and
a fluid leak notification unit (130) installed in a form of an application on a user terminal (310) or provided as a part of a vehicle system (320), and configured to establish a signal connection with the sensor module (120), so as to notify of a risk of leakage of the electrolyte (114) through the user terminal (310) or the vehicle system (320) when the fluid leak detection signal is input,
wherein the weak part (118) is formed to extend from the inner space (116) side toward the outer end on the sealing part (117), and is formed with a bent part (118a) laterally bent between one side in contact with the inner space (116) and the other side in contact with the outer end, so as to cause a momentary excessive pressure, which is introduced from the inner space (116) to the one side, to be collided with the bent part (118a) and be mitigated.

2. The system of claim 1, wherein the weak part (118) is formed to have the bond strength relatively lower than that of the other part (119) because of being relatively less pressurized than the other part (119) by a weak part forming groove (211) formed at a position corresponding to the weak part (118) on any one or more of a first mold (210) and a second mold (220) when the sealing part (117) is compressed between the first mold (210) and the second mold (220).

3. The system of claim 1, wherein the sealing part (117) is formed as the opposite sides of the pouch film (115) are thermally or ultrasonically compressed between the first mold (210) and the second mold (220),
a heterogeneous member (140) made of a material different from the sealing part (117) is provided at the position where the weak part (118) is formed on the sealing part (117), and
the heterogeneous member (140) is made of the material whose bond strength generated by the thermal or ultrasonic compression of each mold (210 and 220) is relatively lower than that of the sealing part (117).

4. The system of claim 1, further comprising:
a leakage fluid accommodation chamber (150) arranged at the outer end of the weak part (118) and having an accommodation space (151) formed therein and connected to the weak part (118), so as to accommodate the electrolyte (114) leaked through the weak part (118) therein,
wherein the sensor module (120) is equipped in the leakage fluid accommodation chamber (150), so as to detect the electrolyte (114) flowing into the accommodation space (151).
